(19) United States
(12) Patent Application Publication
(10) Pub. No.: US 2007/0058667 A1
(43) Pub. Date: Mar. 15, 2007

(54) Apparatus for connecting and disconnecting a computer or other device to a network such as the Internet

(76) Inventors: Timothy Burton, Greenwood, MN (US); Oliver Field, San Jose, CA (US)

Correspondence Address: PLEVY & HOWARD & DARCY P.C., P.O. BOX 226, Fort Washington, PA, 19034, US

(21) Appl. No.: 11/202,907

(22) Filed: Aug. 12, 2005

(51) Int. Cl. G06F 3/00

(52) U.S. Cl. 370/463; 710/1

(57) ABSTRACT

Apparatus for connecting and disconnecting a computer or other device to the Internet includes switching means which has an input and output. The switching means is operative in a first mode to connect the input to the output and in a second mode to disconnect the input from the output. The network output from the computer is coupled to the input of the switching means with the output of the switching means coupled to the network. There are means coupled to the switching means to operate the switching means in either said first or second mode. The switching means utilizes first and second switches each of which are momentary switches. The first switch is associated with a one-shot which triggers the switching means in the first mode while the second switch is associated with a flip-flop which operates the switching means in the second mode. There are means coupled to the flip-flop to assure that when power is applied to the circuit that the switching means always operates in the second or the disconnected mode.

### FIELD OF THE INVENTION

The present invention relates to a network switch and more particularly to a switch to enable a computer or other device to connect and disconnect from a network such as the Internet.

### BACKGROUND OF THE INVENTION

As one can ascertain the Internet is playing an increasing important role in everyday society. The Internet is utilized for many purposes, including the payment of bills, the obtaining of information and obtaining medical records and all sorts of confidential information. It is well known that the Internet or a digital highway such as the Internet is a two way road. Thus one can send information and receive information via such a network. In this manner if the computer is not disconnected from the Internet individuals such as hackers and so on can gain access to the computer via the connection to the Internet and utilize the computer for all types of illegal and fraudulent purposes. Thus a hacker can gain access to a person's computer and for example retrieve information regarding financial transactions and so on. The use of the Internet to enable cyber crime is extremely well known and this has to be protected against. The National Cyber Security Alliance (NCSA) indicates to the consumer to protect himself and others and disconnect from the Internet when not in use. However, most people do not do this because it requires turning off the computer or disconnecting the modem. As one can ascertain turning off a computer requires the computer to then boot up and restart when one wishes to use it again. This is a prolonged process and many people prefer to leave the computer in the ON mode, making it easier to access whenever desired. It is obvious that disconnecting a computer from the Internet when a person is not online lessens the chance that someone will be able to access the computer. If for example a person doesn't have a firewall or anti-virus software an unscrupulous person can gain access to the computer and infect your computer or use it to harm someone on the Internet. Thus it is clear that as indicated by the National Cyber Security Alliance (which is a public/private partnership), one needs to promote cyber security and safe behavior online by making sure that when one is offline one disconnects from the Internet. As indicated this is not an easy procedure and most people prefer not to do this and leave their computer and therefore their modem connected to the Internet even when the computer is not in use.

The present invention provides an Internet standby switch which allows a user to quickly and easily isolate or disconnect his personal computer from the Internet when not in use.

The switch physically switches off the signal and there is no chance of the computer being hacked through the Internet while it is disconnected by the switch. The present switch accommodates either an Ethernet or USB connection to the modem. Power is provided to the switching unit by a USB connection with the option of having an external power supply. This therefore enables a user to quickly and easily connect and disconnect to the Internet, thereby substantially removing the possibility of being invaded by a hacker when the computer is not in use.

### SUMMARY OF THE INVENTION

An apparatus for connecting and disconnecting a computer or other device to a network such as the internet, comprising: switching means having an input and an output and operative in a first mode to connect said input to said output and operative in a second mode to disconnect said input from said output, with the network output from said computer coupled to said input of said switching means and means coupled to said switching means to operate said switching means in either said first or second mode.

### BRIEF DESCRIPTION OF THE FIGURES

FIG. 1 depicts a schematic representation of a computer system which can be connected or disconnected to the Internet via a switch according to this invention.

FIG. 2 depicts a multiple computer connection utilizing multiple switches according to this invention to enable connection and disconnection of the computers to the Internet.

FIG. 3 depicts a WiFi connection utilizing a switch according to this invention to enable connection and disconnection of a computer using RF transmission to the Internet.

FIG. 4 depicts another computer connection utilizing two switches to enable connection to the Internet.

FIG. 5 shows an alternate way of utilizing switches according to this invention to connect various components to the Internet.

FIG. 6 shows still an alternate embodiment of connecting computers to the Internet via USB or CAT5 connections.

FIG. 7 is a schematic view of a switch according to this invention enabling connection and disconnecting of a computer or other device from a network such as the Internet.

### DETAILED DESCRIPTION OF THE INVENTION

Referring to FIG. 1 there is shown a typical connection to the Internet via switch 11 of this invention. In FIG. 1 there is shown a PC 10 which is now connected to the switch 11 for disconnecting and connecting the PC or Personal Computer 10 to or from the Internet. The input of the switch is connected to the Internet output of the computer and the output of the switch is then directed to the input of a router 12 where the router 12 is connected to the Internet 13. Such router connections to the Internet are well known. As seen in FIG. 1 the switch 11 as will be described enables the computer 10 to be connected or disconnected from the Internet by selectively operating the switch in either a first or a second mode. It is also seen in FIG. 1 that the switch according to this invention can be connected at its output to a USB (Universal Serial Bus) or a network cable as the case may be.

Referring to FIG. 2 there is again shown a typical configuration for a home or office layout. As seen in FIG. 2 there are three computers 14, 15 and 16. It is of course understood that many more computers can be utilized as the basic concept is to protect each computer from hackers when not in service. Therefore each computer is associated with a switch according to this invention. Each switch is designated as 17, 18 and 19 whereby each switch is associated with a respective computer. The output of the switches are all directed to inputs of a router 20 where the output of the router again goes to a broadband modem 21 which is connected directly to the Internet 22. As seen in FIG. 2 each switch 17, 18 and 19 can completely isolate the respective personal computer or PC 14, 15 and 16 from the Internet by operating the switch in the OFF mode and also connect to the Internet when the switch is operated in the ON mode.

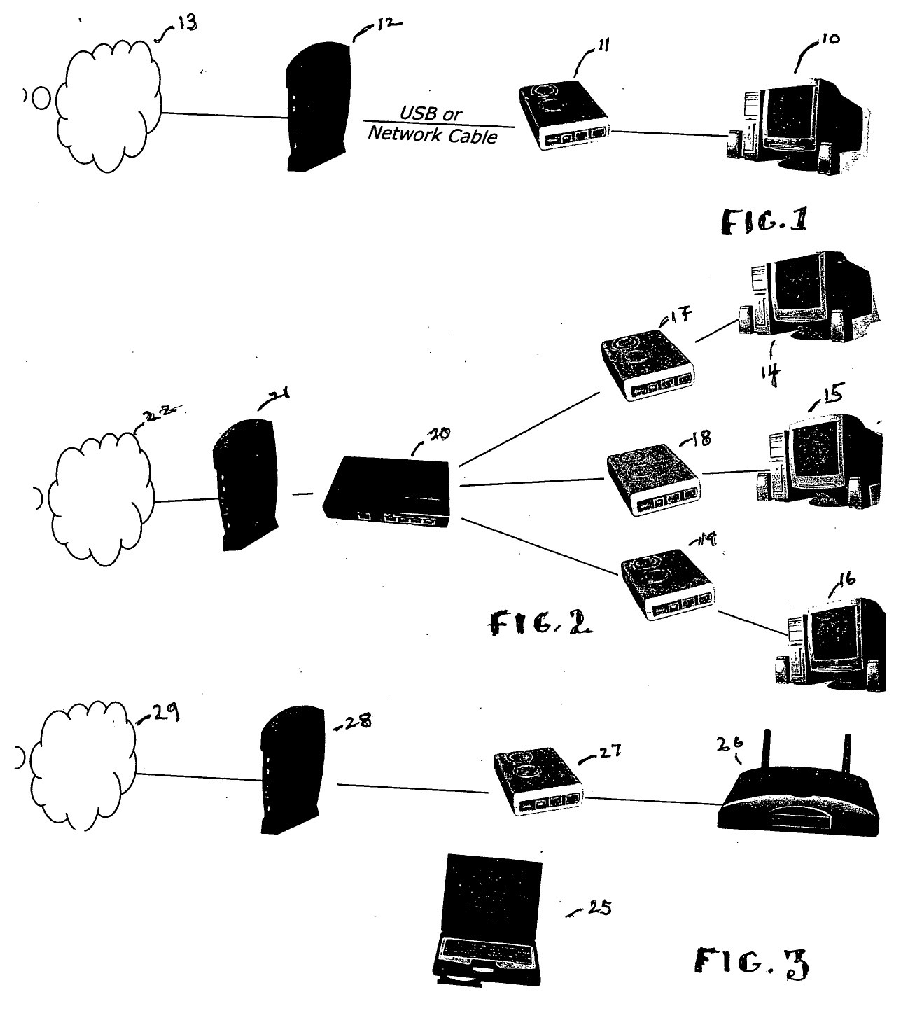

Referring to FIG. 3 there is shown another typical configuration which employs a WiFi access point and a PC with a WiFi notebook. As seen in FIG. 3 the WiFi notebook computer 25 is connected via a high frequency link to the WiFi access point 26. The output of the WiFi access point 26 is connected to the input of the switch 27. The output of the switch 27 is connected to a broadband modem/router 28 which in turn is connected to the Internet 29. If the switch 27 is inactivated this disconnects the WiFi access point 26 from the Internet and therefore isolates the computer 25 from the Internet providing the desired operation whereby when the computer is not in use it is disconnected from the Internet thereby preventing hackers from gaining access to the computer.

Referring to FIG. 4 there is shown still another typical configuration which is employed with modem day communication systems. As seen in FIG. 4 there is a WiFi access point PC with an external USB WiFi adapter. Thus referring to FIG. 4 the personal computer 30 is connected to a switch 31 according to this invention. The output of switch 31 is connected to a USB/WiFi adapter 32. The adapter transmits a signal to a WiFi access point unit 33 which is connected to another switch 34 whose output is connected to a router 35. The output of the router 35 is connected to a broadband modem 36 which in turn is connected to the Internet 37. Essentially as seen in FIG. 4 there are two switches employed; switch 31 disconnects the personal computer from the USB/WiFi adapter 32 while switch 34 disconnects the WiFi access point 33 from the router 35 and therefore provides a disconnect to the Internet. It is noted that two switches are employed because one can gain access to the personal computer 30 by having a WiFi access unit communicating with the USB/WiFi adapter 32. Therefore in FIG. 4 with the configuration shown two switches according to this invention namely 31 and 34 are employed.

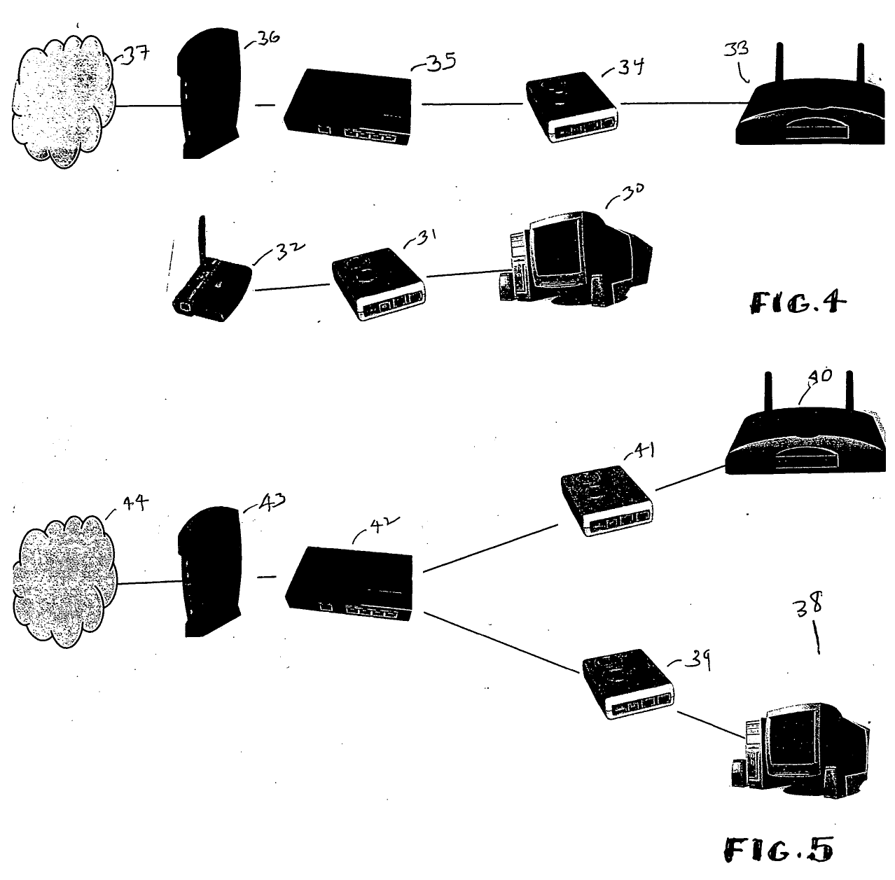

Referring to FIG. 5 there is shown a configuration which uses a wired PC and a WiFi access point. As seen in FIG. 5 the personal computer or PC 38 is connected to the input of switch 39 which in turn has the output connected to the router 42. There is a WiFi access point 40 which is also connected to the input of a switch 41, the output of which is connected to the router 42. The output of the router is connected to a broadband modem 43 which in turn is connected to the Internet. In regard to this configuration the WiFi access point 40 of course can be accessed by many remote computers and therefore needs a switch 41 to isolate the device and computer from the Internet. The switch 39 of course isolates computer 38 from the Internet when not in use.

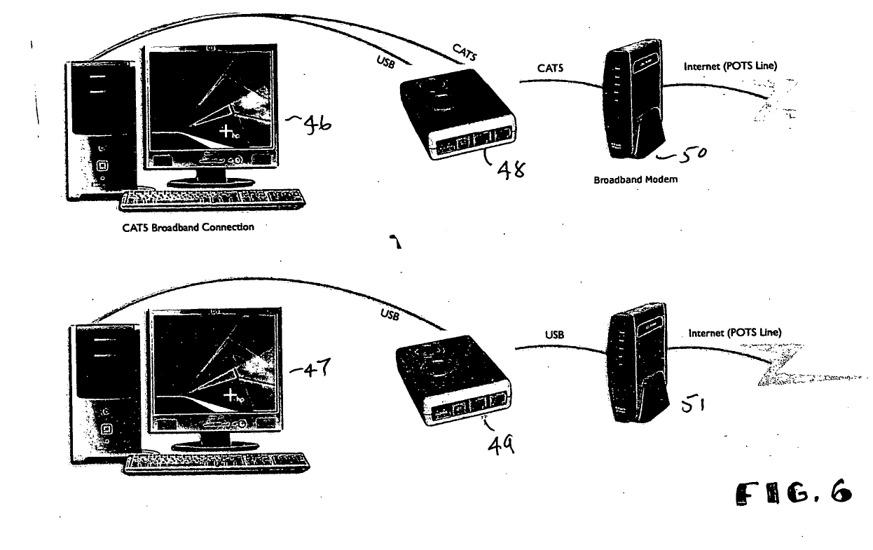

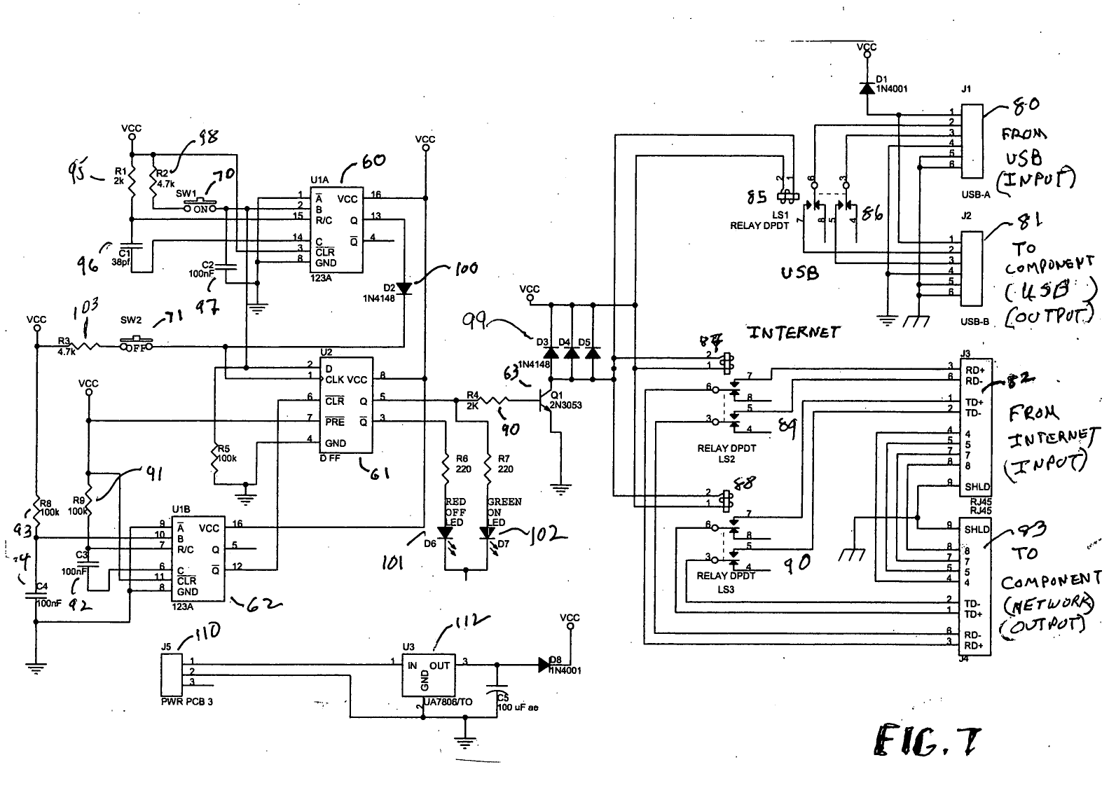

Referring to FIG. 6 there is shown a configuration which is employed with a switch according to this invention. The configuration depicted uses a USB or network cable connection. There is shown a computer 46 which has a CAT5 broadband connection. The CAT5 is connected to the input of the switch 48 where the output of the CAT5 from the switch is connected to a broadband modem 50 which is connected to the Internet through a POTS line. FIG. 6 also depicts a computer 47 with a USB broadband connection connected to a switch 49 which in turn is connected through a USB cable to a broadband modem 51 which is connected to the Internet via a POTS line. Thus as one can see the above noted configurations show most typical network configurations whereby each computer or device is completely isolated from the Internet when not in use by means of the switch according to this invention.

Referring to FIG. 7 there is shown a schematic diagram of an electronic switch such as the switch depicted in FIG. 1 as 11, FIG. 2 as 17, 18, 19 and so on. Essentially as one can see the switch is electronic in nature and the description and operation will be described. Basically the switch contains an input connector designated as J1 (80) and an output connector designated as J2 (81). These connectors are used to connect and disconnect a computer's USB output from a network. There are also two additional connectors which are associated with the Internet, namely J3 (82) and J4 (83). As will be explained, a cable, for example in FIG. 1, from the computer 10, is connected to connector J1 (80) which is a USB connector. If the computer has a USB output and one connects the computer USB output to connector 80, the output of connector 81 then goes to a USB or a network cable interface (to component). Therefore as shown in FIG. 7 the USB output from computer 10 would go to the USB input connector 80 and the USB output emanating from connector 81 will now go to the USB or network cable or other component. In a similar manner connector 82 is associated with the computer Internet connection and therefore the Internet output from a computer will be connected to connector 82 while the output from connector 83 will go to the USB or network cable. As can be seen each of the connectors as 80, 81, 82 and 83 are associated with appropriate relay contacts. Thus the USB jacks 80 and 81 are associated with relay 85 having two contact pair 86. The relay 85 is a Double Pole Double Throw relay (DPDT). The Internet relays are relays 87 and 88; they have contact pairs 89 and 90. Before discussing circuit operation it is understood that the condition shown in FIG. 7 basically is indicative of the OFF position of the switch. Therefore in FIG. 7 there is no connection to the Internet or to the USB and the component as the computer or PC is isolated. For example let us take connector 82; connector 82 has terminal outputs designated as RD+ and RD− . This is for the receive leads. It also has terminal connections TD+ and TD− associated with the transmit leads. Thus the R leads are the receive leads from the computer to go to the Internet while the T leads are the transmit leads to go to the Internet. As seen these connections go through the relay contacts 89 and 90. As seen RD+ of connector 82 is not connected to RD+ of connector 83; therefore the RD+ of connector 82 is isolated from the RD+ of connector 83. In a similar manner the RD−, TD+ and TD− are all not connected to the associated terminals of connector 83. In this manner there is an open circuit and therefore the computer is isolated from the Internet. In a similar manner the USB leads such as 2 and 3 are also not connected because of the fact that the relays are not operated. This position of the relay and contacts as shown in FIG. 7 is indicative of the OFF mode of the switch. As seen all the relay coils as coils 85, 87 and 88 are coupled to the collector output of an NPN transistor 63. The transistor 63 has a series of shunt diodes 99 coupled across the coils which diodes function as arc suppressors. The emitter of transistor 63 is directed to a point of reference potential or ground while the base electrode of transistor 63 is connected to the Q output of a D type flip-flop 61 via a resistor 90. As one can ascertain in the OFF position transistor 63 is off and does not conduct current. In this manner the Q output of D flip-flop 51 which is designated as terminal 5 is also off or at a low position (zero out). Therefore transistor 63 is off and relays 85, 86, 87 and 88 are non-operational, placing the contacts associated with those relays in the positions shown in FIG. 7. As seen the D flip-flop 61 is associated with two mono-stable multi-vibrators namely 60 and 62 or one shot pulse generators. The multivibrator or one-shot 62 operates to ensure that flip-flop 61 always comes on, when power is applied, in the OFF condition (Q=0), therefore assuring that transistor 63 after application of power to the circuit will always be off and therefore relays 85, 86, 87 and 88 will not be operated. This operation occurs as follows: The Q̅ output of one shot 62 is coupled to the clear output 6 of flip-flop 61. One can also see there is an ON switch 70 and an OFF switch 71 both of which are momentary operated switches. The momentary switch 70 and 71 operate to connect the input to the output momentarily and after the actuation returns to the position shown in FIG. 7. The one-shot 62 has a time constant determined by resistor 91 and capacitor 92 which common terminal is connected to the R/C input of the one-shot 62. This determines the pulse width. When VCC or operating voltage is applied, resistor 93 charges capacitor 94 the junction of which is connected to the B input. This causes the one-shot 62 to fire which in turn triggers the clear input of the flip-flop 61 ensuring that the flip-flop 61 is in the OFF or cleared position with Q output being low. Thus the circuit operation always assures that 61 is triggered by one-shot 62 upon application of power and therefore flip-flop 61 will always be the OFF position. This assures that transistor 63 is always off and therefore the circuit operates with the relays in the position shown in FIG. 7 which is the OFF mode of the switch. There is another one-shot 60 whose pulse width is determined by resistor 95 and capacitor 96 the junction between resistor 95 and capacitor 96 is directed to the R/C input of the one-shot. As one can see the one-shot 60 has its B or trigger input coupled to one terminal of the ON switch while that same terminal is coupled through a capacitor 97 to a point of reference potential. A resistor 98 is coupled to the other terminal of switch 70 while the other terminal of resistor 98 is coupled to VCC. Thus as seen in FIG. 7 when switch 70 is operated the B input of one-shot 60 is activated after the time period specified by capacitor 97 and resistor 98; this causes one-shot 60 to trigger, producing a pulse at the Q output. This pulse is transmitted via diode 100 to the clock input of flip-flop 61. Flip-flop 61 is ready to be triggered because its D input as well as its clock input are activated upon the depression of switch 70. Therefore flip-flop 61 changes state from Q being low to Q (terminal 5) being high. When the Q output of flip-flop 61 goes high transistor 63 operates therefore operating relays 85, 87 and 88. This in turn switches the contacts to the opposite positions shown in FIG. 7. The operation of the relays now causes, for example the RD+ lead from connector 82 to be connected to the RD+ lead at connector 83. In a similar manner the remaining leads are also connected together as TD+ to TD+ and so on. This then enables the computer to be connected to the Internet and enables the USB to be properly connected. This is the ON mode of the switch. The computer will stay connected until power is turned off or the OFF switch 71 is activated whereby the relay contacts will revert to the positions shown in FIG. 7. When the OFF switch 71 is momentarily depressed the switch again returns to the OFF mode. As one can see when the OFF switch is momentarily depressed VCC is applied to the clock input of flip-flop 61 via resistor 103. Diode 100 is reverse-biased and flip-flop 61 then triggers to enable Q to go low again and therefore turning transistor 63 off. As can be seen there are two LEDs; one is associated with the OFF and one with the ON position. For example LED 101 is the OFF indicator (Red) and LED 102 is the ON indicator (Green). As seen from FIG. 7 when Q is high LED 102 is on and when Q̅ is high LED 101 is on. Thus there is a green light when the circuit is in the ON mode (LED 102) and a red light when the circuit is in the off mode (LED 101). Also as can be seen there is a separate connector 110 which goes to a voltage regulator 112 to accommodate the output or operating voltage VCC. This voltage is applied to the unit. In any event an external power supply can be applied to connector 110 or when a USB port is being utilized the USB port will provide at the output a voltage which may be converted to VCC. This voltage VCC from the USB can be applied directly to terminal 1 and hence produce a regulated voltage or if the voltage is already regulated then that voltage can be utilized as VCC. In any manner as one can see the above noted electronic switch utilizes momentary switches 70 and 71 to activate the components. The default condition of the electronic switch is always in the OFF position or mode so that relay coils 85, 87 and 88 are not operated when the electronic switch is first turned on. In order to connect to the Internet one has to momentarily depress switch 70 (ON) to turn transistor 63 on and therefore operate the associated relays. This enables a connection from an input connector as 80 to an output connector as 81 regarding USB and enables connection of an input connector 82 to an output connector 83 as far as the Internet is concerned.

While other modes of operation are possible it has been determined that there are alternate structures that one can utilize to supplement operation of the circuit and the alternate structures or embodiments are deemed to be encompassed within the spirit and scope of the claims appended hereto.

What is claimed is:

1. Apparatus for connecting and disconnecting a computer or other device to a network such as the Internet, comprising:
switching means having an input and an output and operative in a first mode to connect said input to said output and operative in a second mode to disconnect said input from said output, with the network output from said computer coupled to the input of said switching means and the output of said switching means coupled to said network such as the Internet; and
means coupled to said switching means to operate said switching means in either said first or second mode to enable connection and disconnection to said network.

2. The apparatus according to claim 1 wherein said network is the Internet.

3. The apparatus according to claim 1 wherein said network output of said computer is the USB output.

4. The apparatus according to claim 1 wherein said means coupled to said switching means includes a first switch capable when operated to operate said switching means in said first mode, and a second switch capable when operated to place said switching means in said second mode.

5. The apparatus according to claim 4 including first indicator means operative to provide an output indication when said switching means is in said first mode and second indication means to provide an indication when said switching means is operated in said second mode.

6. The apparatus according to claim 5 wherein said first and second indicator means are first and second light emitting devices, each of a different color.

7. The apparatus according to claim 4 wherein said first and second switches are momentary switches, a pulse generator coupled to said first switch and operative to provide a pulse output when said first switch is operated to cause said switching means to switch to said first mode during such pulse output.

8. The apparatus according to claim 7 further including a flip-flop having an input coupled to said second switch and operative to switch said switching means to said second mode when said second switch in operated, said flip-flop coupled to said pulse generator to cause said flip-flop to switch from said second mode during the presence of said pulse.

9. The apparatus according to claim 8 further including means coupled to said flip-flop and operative to cause said flip-flop to switch said switching means to said second mode when bias is applied to said means whereby said flip-flop always causes said switching means to switch to said second mode upon application of power.

10. The apparatus according to claim 1 wherein said switching means includes at least one relay coil operative when energized to place said switching means in said first mode, and means coupled to said relay to energize said relay.

11. Apparatus for connecting and disconnecting a computer or other device to a network such as the internet, comprising:
a first connector having a plurality of terminals for connecting to a computer connector which computer connector would normally be connected to said network, a second connector having the same terminal configuration as said first connector, switching means coupled between the terminals of said first and second connectors and operative in a first mode to connect said terminals of said first connector to said terminals of said second connector and operative in a second mode to disconnect said terminals of said first connector to said terminals of said second connector, means coupled to said switching means for operating said switching means in said first or second modes, said means including a first switch operative when operated to switch said switching means to said first mode, a second switch operative when operated to switch said switching means to said second mode, and means coupled to said second switch for operating said switching means in said second mode when power is first applied to said apparatus.

12. The apparatus according to claim 11 wherein said first and second switches are momentary switches.

13. The apparatus according to claim 12 wherein said switching means includes at least one relay having the common terminal of each contact pair coupled to an associated terminal of said second connector and having one contact coupled to an associated terminal said first connector, whereby when said relay is operated in a first mode said terminals of said first and second connectors are connected together and when operated in a second mode said terminals are disconnected.

14. The apparatus according to claim 13 further including a transistor switch coupled to said relay and capable of operating said relay in said first or second mode when said transistor is off or on.

15. The apparatus according to claim 14 further including a flip-flop having one output coupled to the base of said transistor switch to turn said transistor on during one flip-flop state and off during the other state.

16. The apparatus according to claim 15 further including means coupling said flip-flop to said second switch to place said flip-flop in said OFF state upon operation of said second switch.

17. The apparatus according to claim 16 further including a first one shot having an input coupled to said first switch to an output coupled to said flip-flop, said one shot producing an output pulse when said first switch is operated to switch said slip-flop to said ON state during operation of said first switch.

18. The apparatus according to claim 17 further including a second one-shot having an input coupled to a source of potential for providing a pulse output when said source of potential is first energized said pulse output coupled to said flip-flop to switch said flip-flop to said OFF state when said source of potential is first turned on after being off.

19. The apparatus according to claim 15 including a first indicator coupled to said one flip-flop output for providing a first signal during one flip-flop state, and a second indicator coupled to said flip-flop for providing a second signal during said other flip-flop state.

20. The apparatus according to claim 19 wherein said first and second indicators are first and second light emitting devices each of a different color.
